(19) United States
(12) Patent Application Publication
(10) Pub. No.: US 2017/0177787 A1
(43) Pub. Date: Jun. 22, 2017

(54) Computer-implemented method for meta-analyzing independent data sets and computer-readable medium encoded with computer program thereof

(71) Applicant: National Central University, Taoyuan City (TW)

(72) Inventors: Chih-Hao CHEN, Kaohsiung City (TW); Li-Jen SU, Taipei City (TW)

(21) Appl. No.: 14/970,547

(22) Filed: Dec. 16, 2015

(51) Int. Cl. G06F 19/20

(52) U.S. Cl. CPC G06F 19/20

(57) ABSTRACT

A method for meta-analyzing genomewide expression data sets comprises the following steps. First, to gather a plurality of genomewide expression data sets. Next, to identify a list of differentially expressed genes from each data set and to derive a set of overrepresentation statistics from each list. Then, to combine the sets of overrepresentation statistics across the data sets and to perform overrepresentation analysis based on the combined overrepresentation statistics. The overrepresentation analysis gives a p-value to each synergic gene group for testing correlation between the synergic gene group and the phenomenon under study.

### BACKGROUND

Field of Invention

The invention relates to a statistical method, and particularly relates to a statistical method for meta-analyzing independent genomewide expression data sets and apparatus thereof.

Description of Related Art

For the past two decades, genomewide expression analysis, using microarray or the more recent technology of next-generation sequencing, has been a routine tool to gaining insight into molecular mechanisms underlying biological processes such as disease pathogenesis. Although powerful, its effectiveness is often limited by sample availability. For instance, samples for existing studies of Alzheimer's and Parkinson's diseases mostly numbered a few dozens or less because qualifying brain tissues are rare.

Meta-analyzing existing data sets based on independent cohorts provides the only solution and the conventional method combines the data sets first and then analyzes the combined data set as if it had been produced in one batch. The method has two setbacks. One is that its application is limited to data sets of same or similar platforms. The other setback, often referred to as batch effects, is the technical sources of batch-specific variation that have been added to the samples during handling. Batch effects have been difficult to control for and can mask or masquerade as expression patterns associated with the phenomenon under study.

Hence development of a meta-analysis method not limited by platform differences and not affected by batch effects is imperative.

### SUMMARY

The present invention provides a method for meta-analyzing genomewide expression data sets. Procedure of the method follows. First, gather a plurality of genomewide expression data sets. Next, identify a list of differentially expressed genes from each data set and derive from each list a plurality of statistics for evaluating overrepresentation of a system of synergic gene groups in the genes of the list. Then, combine the overrepresentation statistics across the data sets to evaluate overrepresentation of the synergic gene groups in all the differentially expressed genes.

In an embodiment, the data sets are based on different platforms.

In an embodiment, the synergic gene groups are Gene Ontology Functions.

In an embodiment, the synergic gene groups are biological pathways.

In an embodiment, the statistics for evaluating overrepresentation of a synergic gene group comprise number of all genes, number of all genes in the synergic gene group, number of differentially expressed genes and number of differentially expressed genes in the synergic gene group.

In an embodiment, the step of combining overrepresentation statistics comprises summing numbers of all genes across the data sets, summing numbers of all genes in the synergic gene group across the data sets, summing numbers of differentially expressed genes across the data sets and summing numbers of differentially expressed genes in the synergic gene group across the data sets.

In an embodiment, evaluation of overrepresentation employs the Fisher exact test.

Because the described procedure identifies differentially expressed genes separately from each data set, its application is not limited by platform differences and its effectiveness is not affected by batch effects.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the embodiment described below, with reference made to the following drawings:

FIG. 1 outlines the workflow of the embodiment.

FIG. 2 schematically illustrates the workflow of the embodiment.

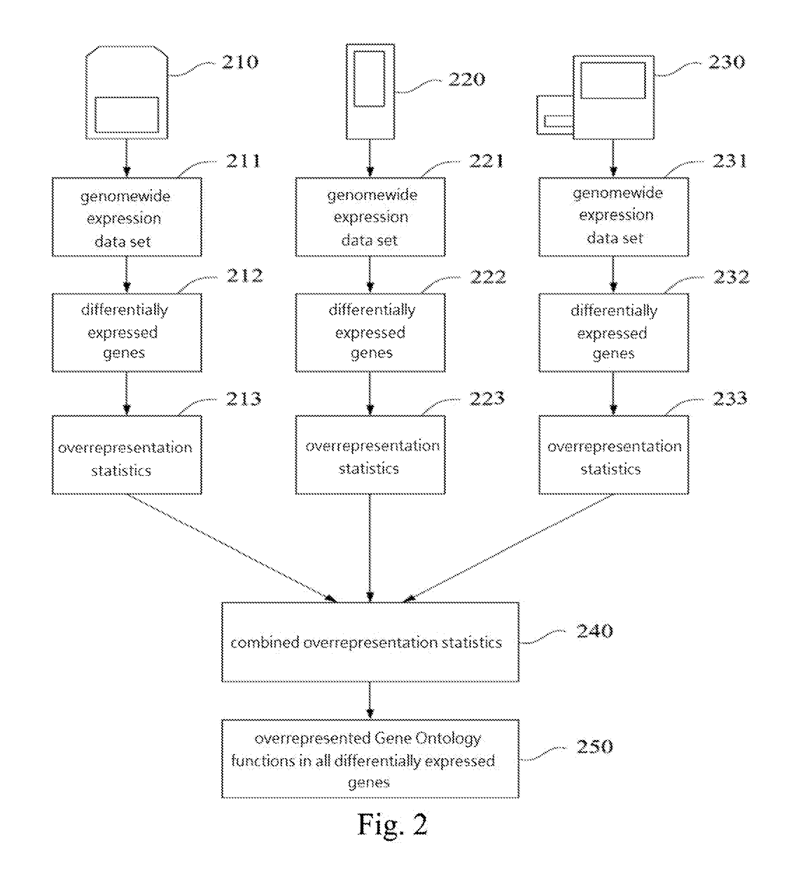

### DETAILED DESCRIPTION

Reference will now be made in detail to the present embodiment of the invention, workflow of which is illustrated in the accompanying drawings. The same reference numbers are used in the drawings and in the description to refer to the same parts.

According to the method in the present invention, differential expression analysis is applied to each genomewide expression data set to identify a list of differentially expressed genes. From the list, a set of overrepresentation statistics for a system of synergic gene groups are derived. These overrepresentation statistics are then combined across the data sets. The combined overrepresentation statistics are then used to evaluate overrepresentation, in terms of p-values, of the synergic gene groups in all the differentially expressed genes. The p-value of a synergic gene group quantifies the possibility that altered expression of the group underlies the phenomenon under study. Because the method applies differential expression analysis to the data sets separately, its application is not limited by platform differences and its effectiveness is not affected by batch effects.

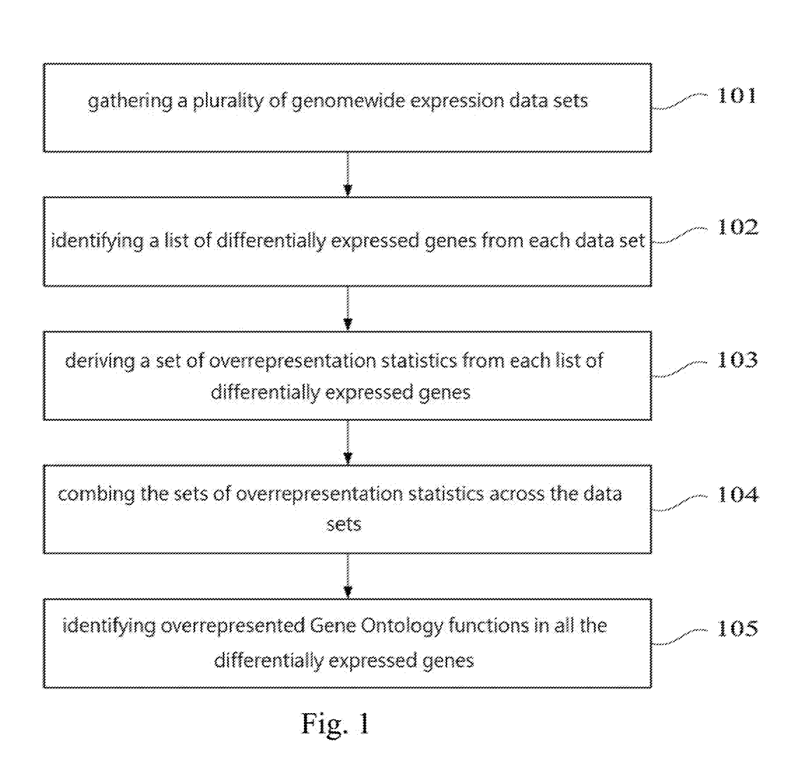

FIG. 1 outlines the workflow of the embodiment. The method 100 may take the form of a computer program product stored on a non-transitory computer-readable storage medium having computer-readable instructions embodied in the medium. Any suitable non-transitory storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives. In the embodiment, the method 100 is used to assess correlation between expression change of a Gene Ontology function and pathogenesis of a disease.

In step 101, a plurality of genomewide expression data sets 211, 221 and 231 are gathered. Based on platforms 210, 220 and 230, these genomewide expression data sets 211, 221 and 231 have been produced by comparing samples from patients of a disease to those from healthy controls.

In step 102, differential expression analysis is separately applied to the genomewide expression data sets 211, 221 and 231 to identify respective lists of differentially expressed genes 212, 222 and 232.

In step 103, a set of overrepresentation statistics for a system of synergic gene groups, the Gene Ontology functions, is derived from the lists of differentially expressed genes. The overrepresentation statistics for a Gene Ontology function are: numbers of all genes (M212, M222, M232), numbers of all genes in the Gene Ontology function (m212, m222, m232), numbers of differentially expressed genes (N212, N222, N232) and numbers of differentially expressed genes in the Gene Ontology function (n212, n222, n232). The numbers M212, m212, N212 and n212 are from the list 212. The numbers M222, m222, N222 and n222 are from the list 222. The numbers M232, m232, N232 and n232 are from the list 232.

In step 104, the overrepresentation statistics from differentially expressed gene lists 212, 222 and 232 are combined. In this embodiment, the overrepresentation statistics from differentially expressed gene lists 212, 222 and 232 are summed across the data sets. That is, for the combined list of differentially expressed genes 240, number of all genes M=M212+M222+M232, number of all genes in the Gene Ontology function m=m212+m222+m232, number of differentially expressed genes N=N212+N222+N232 and number of differentially expressed genes in the Gene Ontology function n=n212+n222+n232.

In step 105, based on the combined overrepresentation statistics, overrepresentation analysis 250 is applied to evaluate an overrepresentation p-value for each Gene Ontology function. In this embodiment, overrepresentation analysis 250 employs the Fisher exact test. The smaller a p-value is, the more likely the Gene Ontology function is associated with pathogenesis of the disease. In another embodiment, the synergic gene groups are biological pathways.

Accordingly, because the method performs differential expression analysis to component data sets separately rather than to the combined data set, its application is not limited by platform differences and its effectiveness is not affected by batch effects.

Although the present invention has been described in considerable detail with reference to an embodiment thereof, other embodiments are possible. Therefore, the spirit and scope of the appended claims should not be limited to the description of the embodiment contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for meta-analyzing genomewide expression data sets, comprising:
gathering a plurality of genomewide expression datasets;
identifying a list of differentially expressed genes from each data set;
for a synergic gene group, deriving a set of overrepresentation statistics from each list of differentially expressed genes;
for the synergic gene group, combining the sets of overrepresentation statistics across the data sets;
for the synergic gene group, performing overrepresentation analysis based on the combined overrepresentation statistics to derive a p-value for testing overrepresentation of the synergic gene group in all the differentially expressed genes.

2. The method of claim 1, wherein the synergic gene groups are Gene Ontology functions.

3. The method of claim 1, wherein the synergic gene groups are biological pathways.

4. The method of claim 1, wherein the overrepresentation statistics of the synergic gene group derived from one of the data sets comprise number of all genes, number of all genes in the synergic gene group, number of differentially expressed genes and number of differentially expressed genes in the synergic gene group.

5. The method of claim 4, wherein combining overrepresentation statistics across the data sets further comprises summing numbers of all genes across the data sets, summing numbers of all genes in a synergic gene group across the data sets, summing numbers of differentially expressed genes across the data sets, and summing numbers of differentially expressed genes in a synergic gene group across the data sets.

6. The method of claim 1, wherein the overrepresentation analysis employs the Fisher exact test.

7. A computer-readable medium encoded with a computer program to execute a method for meta-analyzing genomewide expression data sets, wherein the method comprises:
gathering a plurality of genomewide expression data sets;
identifying a list of differentially expressed genes from each data set;
for a synergic gene group, deriving a set of overrepresentation statistics from each list of differentially expressed genes;
for the synergic gene group, combining the sets of overrepresentation statistics across the data sets;
for the synergic gene group, performing overrepresentation analysis to the combined overrepresentation statistics to derive a p-value for testing overrepresentation of the synergic gene group in all the differentially expressed genes.

8. The computer-readable medium of claim 7, wherein the synergic gene groups are Gene Ontology functions.

9. The computer-readable medium of claim 7, wherein the synergic gene groups are biological pathways.

10. The computer-readable medium of claim 7, wherein the overrepresentation statistics of the synergic gene group derived from one of the data sets comprise number of all genes, number of all genes in the synergic gene group, number of differentially expressed genes and number of differentially expressed genes in the synergic gene group.
